(19) United States
(12) Patent Application Publication
(10) Pub. No.: US 2025/0102810 A1
(43) Pub. Date: Mar. 27, 2025

(54) Adjustable Headbands

(71) Applicant: Apple Inc., Cupertino, CA (US)

(72) Inventors: Ryan M David, San Francisco, CA (US); Benjamin A Shaffer, San Jose, CA (US); Benjamin A Stevenson, Oakland, CA (US); Evan A Cernokus, Campbell, CA (US); Robert V Tang, San Francisco, CA (US); Dustin A Hatfield, Campbell, CA (US); Yuhao Pan, Sunnyvale, CA (US); Erin Bosch, San Jose, CA (US); Alexander Siegel, Hayward, CA (US); Megan Grant, San Francisco, CA (US); Zachary M Hammond, Mountain View, CA (US); Lindsey J Scenna, Santa Clara, CA (US); Alyssa B Abood, Emerald Hills, CA (US); Zilan Chen, Shenzhen (CN); Michael Wu, San Jose, CA (US); Venkata Narayana Murthy Arelekatti, Mountain View, CA (US); Nathaniel M Henderson-Cox, Seattle, WA (US); Chad J Miller, Oakland, CA (US)

(21) Appl. No.: 18/647,046

(22) Filed: Apr. 26, 2024

Related U.S. Application Data
(60) Provisional application No. 63/627,628, filed on Jan. 31, 2024.
(60) Provisional application No. 63/619,855, filed on Jan. 11, 2024.
(60) Provisional application No. 63/585,868, filed on Sep. 27, 2023.

(51) Int. Cl. G02B 27/01

(52) U.S. Cl. CPC G02B 27/0176; G02B 2027/0154

(57) ABSTRACT

A head-mounted device may have a head-mounted housing containing rear-facing displays that display images for a user when the head-mounted housing is worn. The head-mounted housing may be coupled to the user's head using a headband. The headband may include an upper headband portion and a lower headband portion that extends from the first headband portion. The upper and lower headband portions may extend from the head-mounted housing at fixed angles and may be offset from a support post of the head-mounted housing. Stiffeners may be included in the upper and lower headband portions. The stiffeners may include graded stiffeners and/or braided cords that help the upper and/or lower headband portions conform to a user's head. The headband may also include a temple housing coupled to the upper and lower headband portions that has an opening to attach the headband to the support post and/or may include keeper loops.

This application claims the benefit of U.S. provisional patent application No. 63/627,628, filed Jan. 31, 2024, U.S. provisional patent application No. 63/619,855, filed Jan. 11, 2024, and U.S. provisional patent application No. 63/585,868, filed Sep. 27, 2023, which are hereby incorporated by reference herein in their entireties.

### FIELD

This relates generally to headbands, and, more particularly, to adjustable headbands for electronic devices.

### BACKGROUND

Electronic devices such as head-mounted devices may have displays for displaying images. The displays may be housed in a head-mounted support structure.

### SUMMARY

A head-mounted device may have a head-mounted housing containing rear-facing displays that display images for a user when the head-mounted housing is worn by the user. The head-mounted housing may be coupled to the user's head using a headband.

The headband may include upper and lower headband portions. The upper and lower headband portions may extend from the head-mounted housing at fixed angles and may be offset from a support post of the head-mounted housing. The upper headband portion may contact the top of the user's head when worn, while the lower headband portion may contact a lower rear portion of the user's head.

Stiffeners may be included in the upper and lower headband portions. The stiffeners may include graded stiffeners, braided cords, and/or other stiffeners that help the upper and/or lower headband portions conform to the user's head.

The headband may also include one or more temple housings coupled to the upper and lower headband portions. Each temple housing has an opening to attach the headband to the support post of the head-mounted housing. The temple housing may extend into the upper and lower headband portions, or the upper and lower headband portions may be attached to upper and lower edges of the temple housing.

One or more keeper loops may be incorporated into the headband. The keeper loops may be coupled to multiple portions of the headband and may maintain the position of the portions of the headband relative to one another.

The headband may include a woven fabric portion surrounded by a webbing. The webbing may have rounded corners at an edge of the woven fabric portion, and the webbing may appear seamless to the naked eye.

One or more hook and loop fasteners may be coupled to portions of the headband to allow for adjustments to the headband and to maintain the position of the headband after it has been adjusted. Pull tabs may be coupled to surfaces of the headband opposite the hook and loop fasteners to allow for the adjustments.

### BRIEF DESCRIPTION OF THE DRAWINGS

FIG. 1 is a side view of an illustrative electronic device such as a head-mounted display device with an adjustable headband in accordance with some embodiments.

FIG. 2 is a perspective view of an illustrative headband in accordance with some embodiments.

FIG. 3 is a side view of an illustrative headband having upper and lower headband portions that extend from a support member of a head-mounted display device at various angles and/or offsets in accordance with some embodiments.

FIG. 4 is a side view of an illustrative headband having upper and lower headband portions that are attached with an adhesive in accordance with some embodiments.

FIG. 5 is a side view of an illustrative headband having upper and lower headband portions that are formed integrally with each other in accordance with some embodiments.

FIG. 6 is a side view of an illustrative headband having a temple housing that extends into upper and lower headband portions in accordance with some embodiments.

FIG. 7 is a side view of an illustrative headband having a compact temple housing in accordance with some embodiments.

FIG. 8 is a side view of an illustrative headband having a temple housing that has upper and lower edges that respectively attach to upper and lower headband portions in accordance with some embodiments.

FIG. 9A is a front view of an illustrative headband portion having a graded stiffener in accordance with some embodiments.

FIG. 9B is a side view of an illustrative headband portion having a graded stiffener in accordance with some embodiments.

FIGS. 10A-10B are views of an illustrative headband portion have a graded stiffener with a gradual curved profile in accordance with some embodiments.

FIGS. 11A-11C are front views of an illustrative headband portion having stiffeners with modified stiffness at an end of the headband portion in accordance with some embodiments.

FIG. 12 is a front view of an illustrative headband portion having multiple stiffener structures, including a braided cord, in accordance with some embodiments.

FIG. 13 is a front view of an illustrative headband portion having multiple stiffener structures, including a wide stiffener that extends along an edge of the headband portion in accordance with some embodiments.

FIG. 14 is a side view of an illustrative headband that includes a keeper loop to maintain the position of portions of the headband in accordance with some embodiments.

FIG. 15 is a perspective view of an illustrative headband that includes a keeper loop to maintain the position of portions of the headband in accordance with some embodiments.

FIG. 16 is a side view of an illustrative headband that includes a keeper loop and an integrated adjuster loop in accordance with some embodiments.

FIG. 17 is an illustrative front view of an edge of a headband portion in accordance with some embodiments.

FIG. 18 is a top view of an illustrative headband portion with a seam that is invisible to a naked eye in accordance with some embodiments.

FIGS. 19A-19E are views of illustrative hook and loop fasteners that may be coupled to a headband portion in accordance with some embodiments.

FIG. 20 is a side view of an illustrative headband portion with a pull tab in accordance with some embodiments.

FIG. 21 is a perspective view of an illustrative headband system having one or more adjuster loops, keeper loops, and pull tabs in accordance with some embodiments.

### DETAILED DESCRIPTION

Head-mounted devices include head-mounted support structures that allow the devices to be worn on the heads of users. The head-mounted support structures may include device housings for housing components such as displays that are used for presenting a user with visual content. The head-mounted support structures for a head-mounted device may also include headbands and other structures that help hold a device housing on the face of a user. The headband of a head-mounted device may be adjustable.

In some embodiments, it may be desirable to incorporate a bifurcated headband that contacts the user's head in multiple locations while the head-mounted device is worn. The headband may include an upper headband portion that extends over the top of the user's head to support the weight of the head-mounted device and lower headband portion that sits at the lower rear of the head for stability. The upper and lower headband portions may be positioned relative to one another to provide fit and comfort to the user.

The headband may be coupled to a structural support portion of the head-mounted device. In the regions in which the headband is coupled to the structural support portion, the headband may include a graded stiffener. By increasing the rigidity in these regions, the headband may be moment-bearing, adapt to the user's head, and be more comfortable to a user. To prevent the headband from slipping with respect to the user's head, other stiffeners and/or cords may be included on and/or in the headband. If cords are included in the headband, the headband may have adaptive curvature based on the location of the cords within the headband. As a result, the headband may conform to the user's head.

The headband may alternatively or additionally include temple housings in the regions that the headband is coupled to the structural support portion. The temple housings may extend between the upper and lower headband portions, or may have upper and lower edges that are respectively coupled to the upper and lower headband portions. The temple housings may provide increased stiffness in the regions coupled to the structural support portion and therefore may provide additional structural support to the headband.

A keeper loop may be incorporated between different portions of a headband to allow for adjustment of the headband and for maintaining the position of the portions of the headband relative to each other.

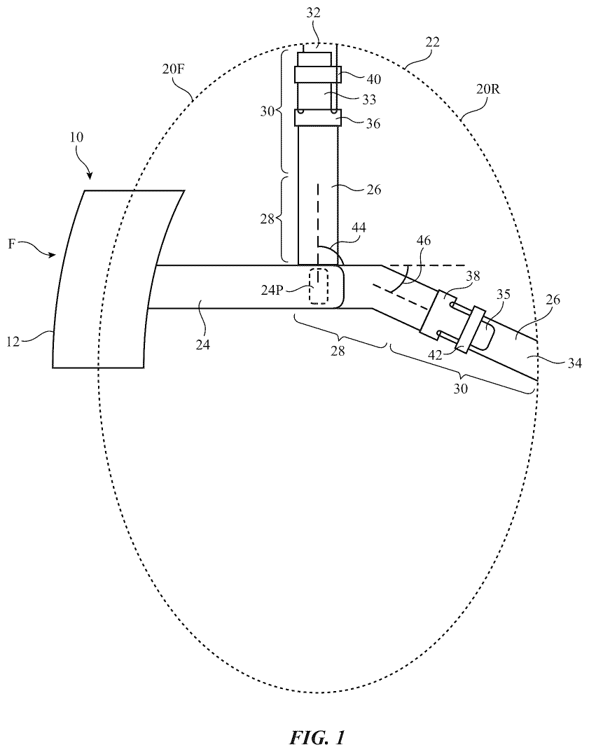

FIG. 1 is a side view of an illustrative head-mounted electronic device with an adjustable headband. As shown in FIG. 1, head-mounted device 10 may include head-mounted housing 12 (sometimes referred to as a main housing, main housing unit, head-mounted support structure, etc.). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, etc.

To present a user with images for viewing from eye boxes (e.g., eye boxes in which the user's eyes are located when device 10 is being worn on the users' head such as head 22 of FIG. 1), device 10 may include displays and lenses. These components may be mounted in optical modules or other supporting structure in housing 12 to form respective left and right optical systems. There may be, for example, a left display for presenting an image through a left lens to a user's left eye in a left eye box and a right display for presenting an image to a user's right eye in a right eye box.

If desired, housing 12 may have forward-facing components such as cameras, other sensors, and/or a display on front F for gathering sensor measurements/other input and/or display information on front F. Housing 12 and may have a soft cushion on an opposing rear side of housing 12. The rear of housing 12 may have openings that allow the user to view images from the left and right optical systems (e.g., when the rear of housing 12 is resting on front surface 20F of the user's head 22.

Device 10 may have an adjustable strap such as adjustable headband 26 and, if desired, may have other structures to help hold housing 12 on head 22. Headband 26 may have first and second ends coupled, respectively, to the left and right sides of housing 12. In the example of FIG. 1, coupling members 24 (also referred to as support structure 24 and support members 24 herein), which serve as extensions of housing 12 (e.g., extend from housing 12 directly or are attached directly to housing 12), are provided on the left and right sides of housing 12. Members 24 may be formed from rigid materials such as rigid polymer and/or other materials and may contain sensors, buttons, speakers, and other electrical components. Hinges and/or other mechanisms may be used to couple members 24 to housing 12 or members 24 may be formed as integral portions of a main housing unit. The ends of headband 26 may have coupling mechanisms such as openings configured to receive posts or other protrusions 24P on members 24 or other housing structures. These coupling mechanisms allow a user to removably attach headband 26 to members 24 and thereby removable attach headband 26 to housing 12. Members 24 may have elongated shapes of the type shown in FIG. 1 and/or other suitable shapes and may sometimes be referred to as rigid straps, rigid coupling members, or power straps.

Headband 26 may include two headband portions 32 and 34. In particular, headband portions 32 and 34 may form two portions of the same headband 26 (e.g., headband portions 32 and 34 may be attached, formed integrally, or otherwise coupled to form headband 26). Headband portion 32 may be an upper headband portion (also referred to as upper headband 32 and upper headband portion 32 herein) that extends over head 22, thereby supporting device 10 on the user's face. Headband portion 34 may be a lower headband portion (also referred to as lower headband 34 and lower headband portion 34 herein) that extends across the lower rear of head 22 and may be moment-bearing. In this way, headband portions 32 and 34 may support device 10 on head 22.

Upper headband portion 32 may be formed at angle 44 from coupling member 24. Angle 44 may be 90°, between 70° and 100°, at least 80°, or other suitable angle. Lower headband portion 34 may be formed at angle 46 from coupling member 24. Angle 46 may be 40°, at least 35°, between 35° and 45°, or other suitable angle. By spacing headband portions 32 and 34 from coupling member 24 by angles 44 and 46, respectively, headband portions 32 and 34 may be maintained in positions to support device 10 on the user's face.

Upper and lower headband portions 32 and 34 may have soft flexible portions such as central portions 30. Portions 30 may be formed between two stiffer portions such as end portions 28 on the left and right ends of upper and lower headband portions 32 and 34. Portions 28 may be stiffened using embedded polymer stiffeners (e.g., single-layer or multilayer polymer stiffening strips), stiffeners on one or more surfaces of headband 26, stiffeners between fabric layers of headband 26, and/or other stiffening members.

Portions 30 may be formed from a stretchable material such as stretchy fabric and/or thin webbing materials. Portions 30 may, as an example, be formed from a band of flat knit fabric that includes stretchable strands of material (e.g., elastomeric strands) and/or which uses a stretchable fabric construction (e.g., a stretchable knit construction). Alternatively, portion 30 may be formed from a band of woven fabric, which may include stretchable strands of material and/or may use a stretchable fabric construction. Narrowed end portions of the band of knit fabric may, if desired, extend over stiffening members in end portions 28 (e.g., to ensure that headband 26 has a uniform external appearance).

Portion 30 in upper headband portion 32 may include a non-stretch insert, such as a plastic sheet. For example, the non-stretch insert may be thermoplastic polyurethane (TPU) or other suitable non-stretch material. The non-stretch material may be embedded in the fabric that otherwise forms portion 30. The presence of the non-stretch material may support the head-mounted device on the user's head. However, the use of a non-stretch insert in portion 30 of upper headband portion 32 is merely illustrative. A non-stretch insert may be incorporated into upper headband portion 32 and/or lower headband portion 34.

The stretchability of portions 30 (and therefore headband portions 32 and 34 of headband 26) allows headband 26 be stretched along its length. This allows the length of headband 26 to be temporarily increased to help a user place headband 26 over the user's head when a user is putting on device 10. When headband 26 is released, the stretchiness and elastic nature of portions 30 of headband 26 will help shorten headband 26 and pull headband 26 against the user's head so that headband 26 rests against the user's head.

Further adjustment of the tension of headband 26 to secure headband 26 and device 10 on the user's head may be provided by tightening doubled-backed portions 33 and 35 of headband 26. In particular, doubled-backed portions 33 and 35 may pass through adjustment loops 36 and 38, respectively. Adjustment loops 36 and 38 may be formed from metal, polymer, or other suitable material.

Doubled-backed portions 33 and 35 may have hook-and-loop fasteners on an inner surface, allowing doubled-backed portions 33 and 35 to be secured to upper and lower headband portions 32 and 34. The hook-and-loop fasteners may be, for example, hair-safe hook-and-loop fasteners that prevent hair from being caught in the fasteners. In this way, headband portions 32 and 34 may be tightened or loosened as desired by a user of device 10.

Soft keeper loops 40 and 42 may maintain the positions of double-backed portions 33 and 35, respectively. In particular, soft keeper loops 40 and 42 may be formed from fabric (either the same fabric as portions 30 or a different fabric from portions 30) and/or stiffener material, if desired. Soft keeper loops 40 and 42 may keep double-backed portions 33 and 35 (and therefore headband portions 32 and 34) flat against head 22. Additionally or alternatively, soft keeper loops 40 and 42 may provide additional friction against the head/hair of the user and therefore help maintain the positions of headband portions 32 and 34 on the head.

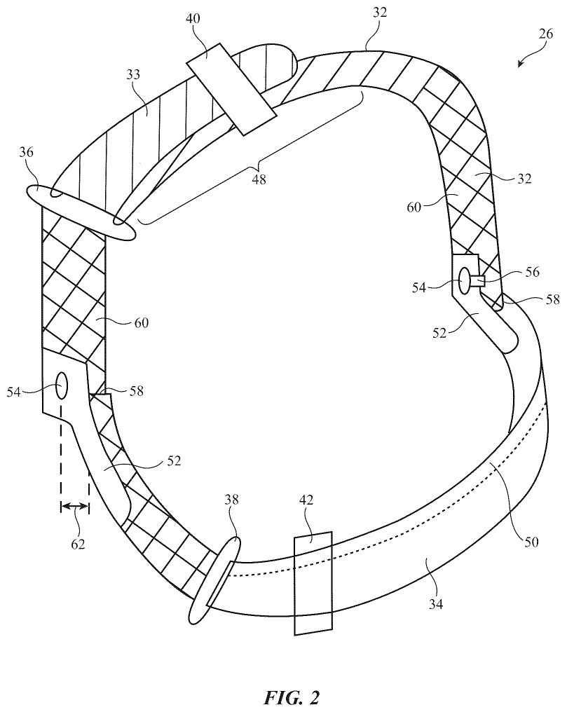

A perspective view of an illustrative headband is shown in FIG. 2. As shown in FIG. 2, headband 26 may include upper headband portion 32 and lower headband portion 34. Headband portions 32 and 34 may meet at locations 58. At locations 58, headband portions 32 and 34 may be adhesively attached (e.g., one of headband portions 32 or 34 may be on top of the other headband portion with an intervening adhesive layer that attaches upper headband portion 32 to lower headband portion 34). Alternatively, headband portions 32 and 34 may be formed integrally from the same fabric layer. In other words, headband portions 32 and 34 may be formed from continuous strips of fabric that extend from lower headband portion 34 to upper headband portion 32 on the left and right sides of headband 26. However, these examples are merely illustrative. In general, headband portions 32 and 34 may be coupled together in any suitable manner.

Upper headband portion 32 may have portions 60 that extend vertically along the sides of the user's head when worn. Portions 60 may be soft-fabric portions. In other words, portions 60 may be formed from stretchable fabric that allow upper headband portion 32 to stretch and conform to a user's head. Portions 60 may correspond with portions 30 of FIG. 1, for example. Alternatively, portions 60 may include an internal stiffener (e.g., a stiffener embedded between fabric layers or fabric surfaces of upper headband portion 32), such as a plastic stiffener. If portions 60 are stiffened, portions 60 may have improved in-plane rigidity, and headband 26 may maintain its shape both on and off of the user's head.

Upper headband portion 32 may also have portion 48 that extends over the top of the user's head when worn. Portion 48 may have a non-stretch insert, such as a plastic sheet (e.g., thermoplastic polyurethane). The non-stretch insert may be embedded within the fabric of upper headband portion 32, attached to a surface of upper headband portion 32, or otherwise included within headband portion 32.

The non-stretch insert may ensure that upper headband portion 32 maintains its shape both on and off of the user's head. For example, the non-stretch insert may maintain the shape of upper headband portion 32 when it is removed from the user's head (or as it is being put onto the user's head), thereby making it easier for a user to put on headband 26. However, the use of a non-stretch insert is merely illustrative. If desired, other stiffener structures or no stiffener structures may be incorporated into portion 48 of upper headband portion 32.

Lower headband portion 34 may include stiffener 50 that extends along an edge (the upper edge in FIG. 2) of lower headband portion 34. Stiffener 50 may be embedded within the fabric of lower headband portion 34, attached to a surface of headband portion 34, or otherwise included within headband portion 34. In some illustrative embodiments, stiffener 50 may be inserted into a cavity within lower headband portion 34 to extend along an edge of lower headband portion 34.

Stiffener 50 may be formed from a cord, such as a braided cord, sheets of fabric, a non-stretch cord, or a flexible strip of polymer (e.g., an elastomer such as thermoplastic polyurethane), as examples. Stiffener 50 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffener 50 may significantly less stretchy and soft than the fabric of lower headband portion 34 and may serve to increase the stiffness and decrease (or eliminate) stretchiness at desired portions along lower headband portion 34. At the same time, the flexibility of stiffener 50 may allow lower headband portion 34 to bend around the curvature of a user's head. Stiffener 50 may be inserted into selected portions of lower headband portion 34 to selectively stiffen lower headband portion 34 at desired portions along its length, if desired. In this way, stiffener 50 may allow lower headband portion 34 to conform to the lower rear of the user's head.

Although upper headband portion 32 is shown as including a non-stretch insert in double-backed portion 33 and lower headband portion 34 including stiffener 50, this is merely illustrative. Upper headband portion 32 and/or lower headband portion 34 may include one or more non-stretch inserts and/or one or more stiffeners.

Headband 26 may include temple housings 52 that bridge upper headband portion 32 and lower headband portion 34. Temple housings 52 may be formed from a rigid polymer, such as plastic, metal, plastic embedded in fabric, plastic covered by silicon, or any other suitable material. In general, temple housings 52 may be more rigid than upper headband portion 32 and lower headband portion 34.

Temple housings 52 may have openings 54. Openings 54 may receive a post, such as post 24P of FIG. 1, to attach headband 26 to a head-mounted device. Openings 54 may have an elongated shape that matches the shape of post 24P, as an example. Temple housings 52 may also have tabs 56. Tabs 56 may be attached to a latch (or other suitable attachment mechanism) in openings 54 that attaches headband 26 to post 24P. By pulling on tabs 56, a user may release the latch from post 24P, and headband 26 may be removed from member 24 (FIG. 1). However, this attachment mechanism of headband 26 to member 24 is merely illustrative. In general, headband 26 may attach to member 24 in any suitable manner.

Openings 54 may be offset from a rear edge of upper headband portion 32 by distance 62. Distance 62 may be at least 20 mm, 25 mm, 10 mm or more, 0 mm, between 10 mm and 25 mm, or other suitable amount. In general, distance 62 may be selected to ensure that headband 26 supports a head-mounted device on a user's head.

Temple housings 52 may be formed on outer surfaces of headband 26 (e.g., the surfaces of headband 26 that face away from the head of the user when worn), may be formed on inner surfaces of headband 26 (e.g., the surfaces of headband 26 that face the head of the user when worn), and/or may be at least partially embedded within fabric that forms headband 26. By including temple housings 52 in the regions of headband 26 that attach to post 24P, headband 26 may have additional rigidity/stiffness in these regions. As a result, the angles of upper headband portion 32 and lower headband portion 34 may be maintained around temple housings 52, making headband 26 easier for a user to put on. Additionally, the more rigid connection between headband 26 and post 24P may allow headband 26 to support the head-mounted device on the user's face more effectively.

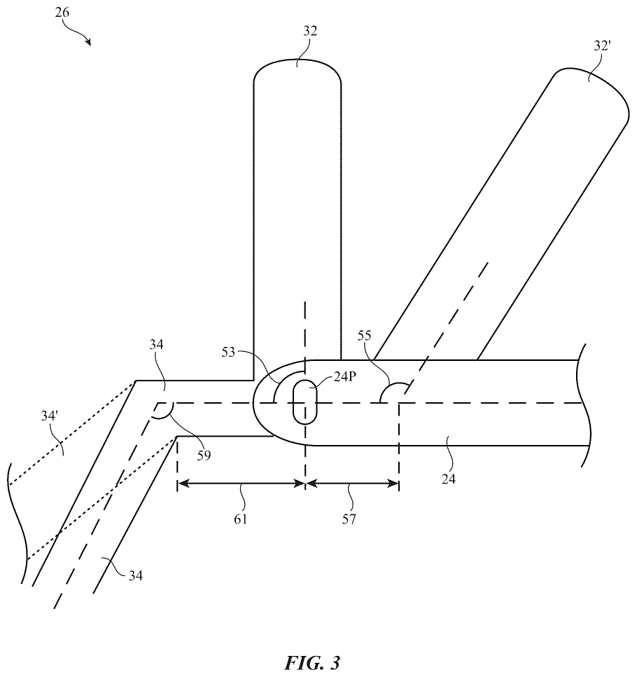

As shown in FIGS. 1 and 2, upper headband portion 32 and lower headband portion 34 may be offset from one another by a given angle, and opening 54 may be offset from upper headband portion 32 (or lower headband portion 34) by a given distance. Illustrative examples of different angles and offsets between portions of a headband are shown in FIG. 3.

As shown in FIG. 3, upper headband portion 32 may be formed at 90° angle 53 with respect to support member 24 and be at a 0 mm offset from post 24P. Alternatively, upper headband portion 32 may be at position 32′ at angle 55 with respect to support member 24. Angle 55 may be greater than 90° (e.g., may place upper headband portion 32 closer to the front top of the user's head), may be 135° may be between 100° and 140°, or may be another suitable angle.

Alternatively or additionally, upper headband portion 32 may be offset from post 24P (and therefore from lower headband portion 34) by distance 57. Distance 57 may be at least 10 mm, at least 20 mm, between 10 mm and 20 mm, or other suitable distance.

Similarly, lower headband portion 34 may be at angle 59 with respect to support member 24 and may be offset from support post 24P by distance 61. Angle 59 may be, for example, 45°, 50°, between 35° and 55°, 40°, or other suitable angle. For example, lower headband portion 34 may be at position 34′ at a greater angle relative to support member 24.

Distance 61 may be at least 15 mm, at least 20 mm, between 18 mm and 35 mm, 25 mm, 33 mm, 18.5 mm, or other suitable distance.

By adjusting the angle and offset of upper headband portion 32 and lower headband portion 34, headband 26 may support a head-mounted device on the head of the user.

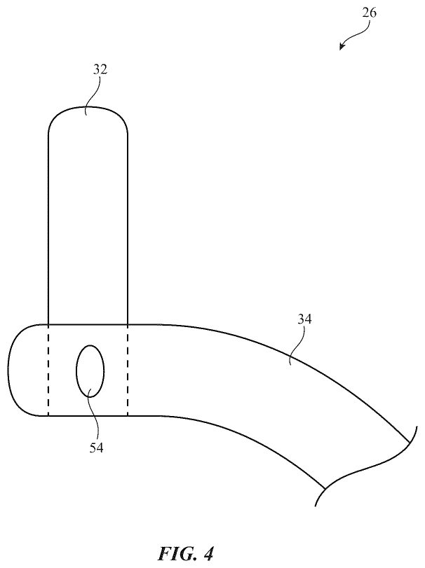

Regardless of the angle and offset of upper headband portion 32 and lower headband portion 34, the two portions are attached, formed integrally, or otherwise coupled to form headband 26. An illustrative example of a headband having two portions that are attached to one another is shown in FIG. 4.

As shown in FIG. 4, lower headband portion 34 may overlap upper headband portion 32. Opening 54 may extend through both upper headband portion 32 and lower headband portion 34. Additionally, lower headband portion 34 and upper headband portion 32 may be adhesively attached to one another. For example, a layer of adhesive may be incorporated between upper headband portion 32 and lower headband portion 34 to couple the two portions together.

Although not shown in FIG. 4, a temple housing, such as temple housing 52 of FIG. 2, may be incorporated in headband 26 of FIG. 4. For example, a temple housing may be formed on the surface of lower headband portion 34, the surface of upper headband portion 32, and/or between lower headband portion 34 and upper headband portion 32. In this way, headband 26 may be reinforced near opening 54.

Moreover, although FIG. 4 shows lower headband portion 34 formed on top of upper headband portion 32, this is merely illustrative. If desired, upper headband portion 32 may be formed on top of lower headband portion 34, and the two band portions may be adhesively attached.

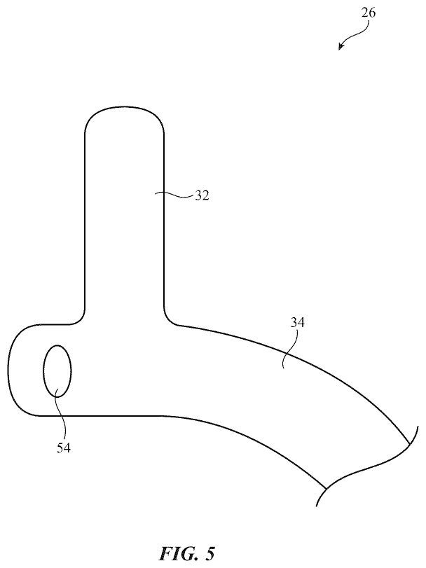

As an alternative to adhesively attaching the upper and lower headband portions, the two headband portions may be formed integrally with one another. As shown in illustrative FIG. 5, headband 26 may include a continuous fabric portion that forms both upper headband portion 32 and lower headband portion 34. Opening 54 may be formed in the continuous fabric portion.

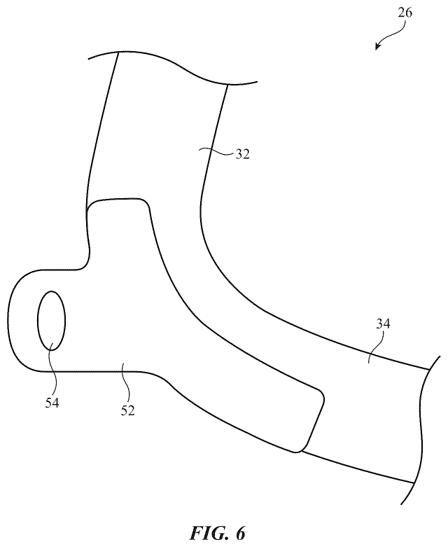

Although not shown in FIG. 5, a temple housing, such as temple housing 52 of FIG. 2, may be incorporated in headband 26 of FIG. 5. For example, as shown in the illustrative example of FIG. 6, temple housing 52 may be formed on the continuous fabric portion that forms both upper headband portion 32 and lower headband portion 34. Alternatively, temple housing 52 may be embedded in the continuous fabric portion that forms upper headband portion 32 and lower headband portion 34. Regardless of where temple housing 52 is formed relative to the surface(s) of upper and lower headband portions 32 and 34, temple housing 52 may extend vertically into both upper headband portion 32 and lower headband portion 34. In this way, headband 26 may be reinforced near opening 54.

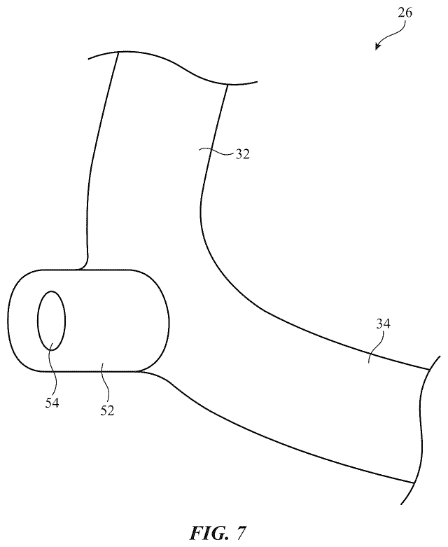

Although temple housings 52 have been shown and described as being elongated structures that extend vertically between upper headband portion 32 and lower headband portion 34, and across only part of the width of headband 26, this is merely illustrative. An illustrative example of a compact temple housing that does not extend vertically into the upper and lower headband portions is shown in FIG. 7.

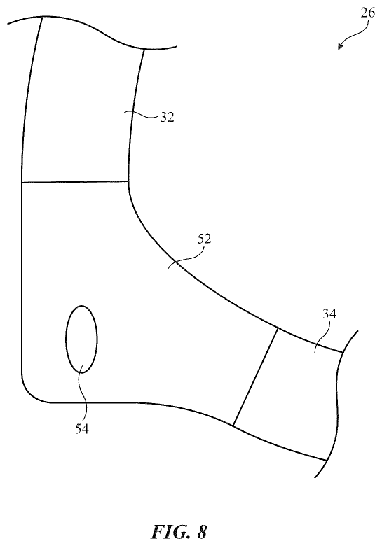

As shown in FIG. 7, temple housing 52 may extend horizontally within headband 26, without extending vertically into upper headband portion 32 and lower headband portion 34. In this way, temple housing 52 of FIG. 7 may be a compact temple housing. As another illustrative alternative, as shown in FIG. 8, temple housing 52 may extend entirely across headband 26. In some embodiments, upper band portion 32 and lower band portion 34 may be coupled to the upper and lower edges of temple housing 52 of FIG. 8 (e.g., temple housing 52 may fill a gap between upper band portion 32 and lower band portion 34).

In general, regardless of the shape of temple housing 52, one or more temple housings 52 may be formed on outer surfaces of headband 26 (e.g., the sides opposite the user's head when headband 26 is worn), inner surfaces of headband 26 (e.g., the sides that contacts or is adjacent to the user's head when headband 26 is worn), and/or in between fabric layers of headband 26. For example, temple housing 52 may have fabric on either side of temple housing 52, and the same fabric (or fabric coupled to that fabric) may form upper band portion 32 and lower band portion 34.

Additionally or alternatively, the rigidity that temple housing 52 provides to headband 26 may be increased by one or more additional stiffeners around the region of opening 54. For example, internal stiffeners (stiffeners embedded in the headband fabric) and/or external stiffeners (stiffeners on one or more surfaces of the headband fabric) may be used to further increase the rigidity of headband 26 in these regions. The internal and/or external stiffeners may be formed from polymer, metal, or other suitable stiffening material.

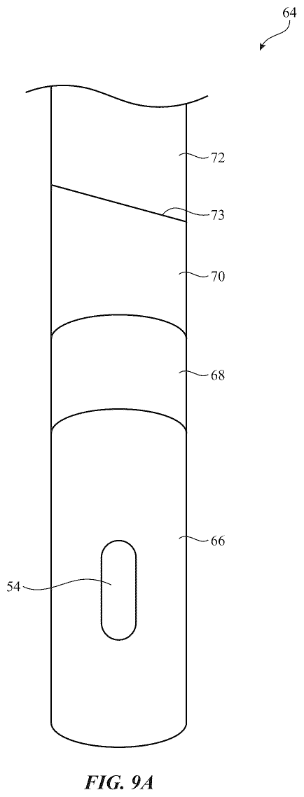

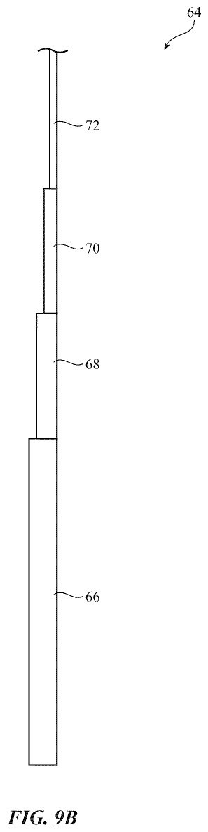

As discussed, one or more portions of upper headband portion 32 and/or lower headband portion 34 may be stiffened. For example, portion 48, portion 60, and/or portion of upper headband portion 32 in which stiffener 50 is formed of FIG. 2 may be stiffened, such as using an internal stiffener (e.g., a stiffener embedded between fabric portions of the headband). In some embodiments, it may be desirable to gradually vary the thickness of the headband in the portions. An illustrative example of a headband portion having gradually varied stiffness is shown in FIG. 9A.

As shown in FIG. 9A, headband portion 64, which may be upper headband portion 32 or lower headband portion 34, may have stiffened regions 66, 68, 70, and 72. Stiffened region 66 may include opening 54 for a support post (such as post 24P), and therefore may be the most rigid/stiff portion of headband portion 64. Therefore, stiffened region 66 may include at least 0.5 mm, at least 0.6 mm, between 0.5 mm and 1.0 mm, or other suitable thickness of stiffening material, such as a polymer, such as polyethylene terephthalate (PET), metal, or other suitable material. Stiffened region 68 may be slightly less stiff than stiffened region 66, and therefore may include less than 0.6 mm, 0.4 mm, between 0.3 mm and 0.6 mm, or other suitable thickness of the stiffening material (either the same stiffening material as in stiffened region 66 or a different stiffening material). Stiffened region 68 may have a length of 25 mm, at least 20 mm, between 10 mm and 25 mm, or other suitable length, as examples. Stiffened region 70 may be slightly less stiff than stiffened region 68, and therefore may include less than 0.4 mm, 0.2 mm, between 0.1 mm and 0.3 mm, or other suitable thickness of the stiffening material (either the same stiffening material as in stiffened region 66 and/or 68, or a different stiffening material). Finally, stiffened region 72 may be slightly less stiff than stiffened region 70 and therefore may include 0.1 mm, between 0.05 mm and 0.15 mm, or other suitable thickness of the stiffening material (either the same stiffening material as in stiffened region 66, 68, and/or 70, or a different stiffening material). In this way, the stiffness of headband portion 64 may be gradually reduced between stiffened region 66 and stiffened region 72. In other words, the stiffening material in stiffened regions 66, 68, 70, and 72 may form a graded stiffener having a graded stiffness in headband portion 64.

The thickness of the stiffening material in stiffened region 66, 68, 70, and/or 72 may be done using multiple layers of the stiffening material in each region, or a single layer of stiffening material in each region.

One or more of stiffened regions 66, 68, 70, and 72 may also have a tapered portion to gradually change the stiffness along a width of headband portion 64. As an illustrative example, in FIG. 9A, tapered edge 73 may be incorporated between stiffened region 70 and stiffened region 72. In this way, headband portion 64 may have higher stiffness on the left edge of FIG. 9A than the on the right edge of FIG. 9A. However, this arrangement is merely illustrative. In general, any one or more of the stiffened regions may have tapered edges.

The gradual thickness (and therefore stiffness) reduction of stiffened regions 66, 68, 70, and 72 is shown in the illustrative side view of FIG. 9B. By gradually reducing the stiffness of headband portion 64, headband portion 64 may be designed to better conform to a user's head (e.g., the top of the user's head if headband portion 64 is upper headband portion 32, or the lower rear of the user's head if headband portion 64 is lower headband portion 34).

Although not shown in FIGS. 9A and 9B, headband portion 64 may also include other stiffener structures, such as stiffener 50 of FIG. 2, and/or a temple housing, such as temple housing 52 of FIG. 2. In general, headband portion 64 may include any suitable stiffener structures.

Moreover, beyond stiffened region 72 (or any suitable stiffened region), headband portion 64 may be formed from unstiffened fabric (or fabric with a non-stretch insert, such as is shown in portion 48 of FIG. 2). In general, any suitable number of stiffened regions may be incorporated between stiffened region 66 and the unstiffened fabric.

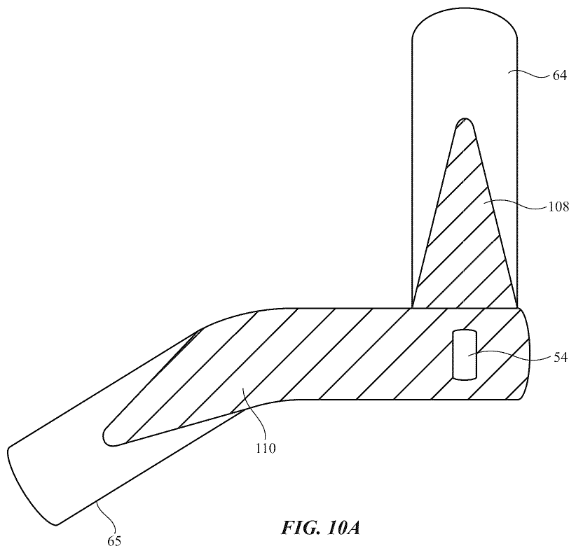

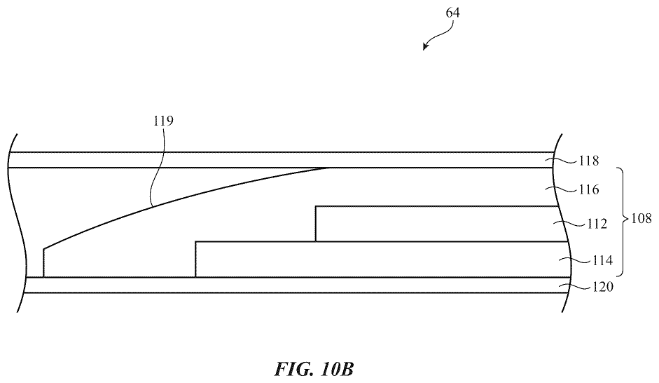

Although FIGS. 9A and 9B show a gradual thickness reduction with multiple portions that gradually change thickness in a staggered (e.g., staircase) arrangement, this is merely illustrative. In some embodiments, a stiffener that gradually changes thickness in a sloped manner may be used in a headband strap. An illustrative example is shown in FIGS. 10A and 10B.

As shown in FIG. 10A, headband portion 64, which may be upper headband portion 32, may have stiffener 108, and headband portion 65, which may be lower headband portion 34, may have stiffener 110. Stiffeners 108 and 110 may be tapered, such as in the illustrative triangular shape of FIG. 10A. In general, however, stiffeners 108 and 110 may be tapered in any suitable manner.

FIG. 10B shows an illustrative side view of headband portion 64 with stiffener 108. As shown, stiffener 108 may be formed between fabric layers 118 and 120. Stiffener 108 may be adhesively attached to fabric layers 118 and 120, may be stitched or otherwise incorporated into headband portion 64, or may otherwise be attached to headband portion 64.

Stiffener 108 may include stiffener layers 112 and 114, which may be formed from

PET, metal, polymer, or other suitable material. Stiffener layers 112 and 114 may have thicknesses of at least 0.05 mm, between 0.5 mm and 0.2 mm, less than 0.3 mm, or other suitable thicknesses. As shown, stiffener layer 114 may extend further than stiffener layers 112. In this way, headband portion 64 may be stiffer in regions in which stiffener layers 112 and 114 overlap, and less stiff in regions in which stiffener layer 114 is present without stiffener layer 112.

Stiffener encapsulation layer 116 may overlap stiffener layers 112 and 114. Stiffener encapsulation layer 116 may be formed from TPU, elastomer, plastic, or other suitable material. As shown in FIG. 10B, stiffener encapsulation layer 116 may have tapered profile 119. For example, stiffener encapsulation layer 116 may be gradually tapered so that stiffener 108 has a thickness of less than 0.15 mm, of 0.1 mm, of less than 0.2 mm, of between 0.5 mm and 0.15 mm, or other suitable thickness at an end in which stiffener layers 112 and 114 are not present (the left side of FIG. 10B) to a thickness of at least 0.4 mm, between 0.3 mm and 0.5 mm, at least 0.5 mm, or other suitable thickness in the region in which stiffener layers 112 and 114 are present (the right side of FIG. 10B). In this way, stiffener 108 may have a gradually tapered profile, rather than a step/staircase profile in the examples of FIG. 9.

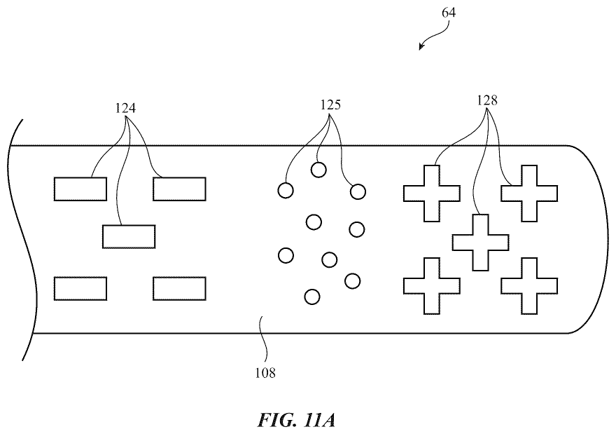

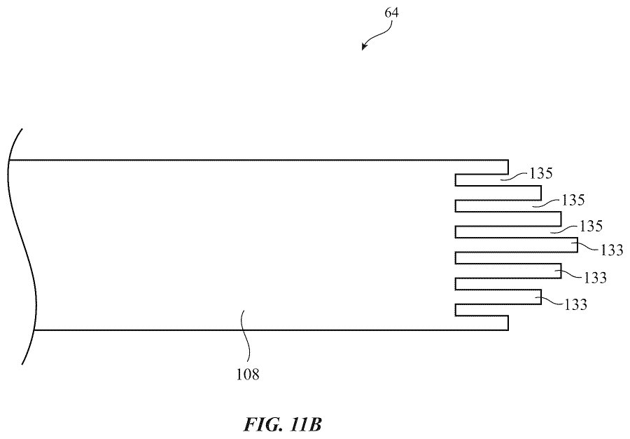

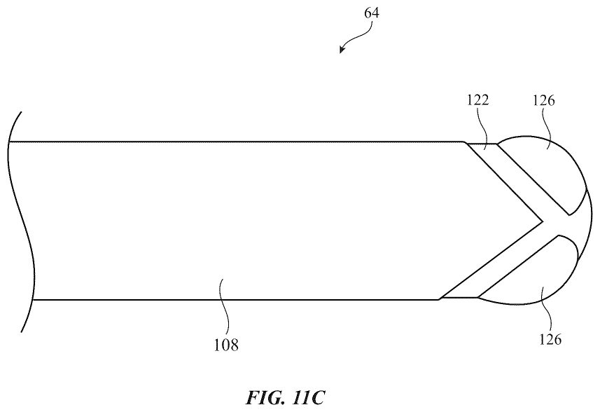

Alternatively or additionally, the stiffener(s) may be modified at an edge of a headband to provide a smooth transition between the stiffened regions and the non-stiffened regions. Illustrative examples of modified stiffeners are shown in FIGS. 11A-11C.

As shown in FIG. 11A, stiffener 108 in headband portion 64 may have an array of slits 124, holes 125, and/or shapes 128. The shapes shown in FIG. 11A are merely illustrative. In general, by including slits, holes, and/or openings of other shapes, stiffener 108 may be less stiff in regions with the openings. Therefore, an array may openings may be formed in stiffener 108 to gradually reduce the stiffness of stiffener 108 as stiffener 108 gets closer to the end of headband portion 64. For example, the array of openings may be denser closer to the end of headband portion 64 than toward the central portion of headband portion 64. In general, however, the stiffness of stiffener 108 may be modified in any desired manner.

In other embodiments, as shown in the illustrative example of FIG. 11B, stiffener 108 may have slit openings 135. In particular, slit openings 135 may be cut between portions 133 of stiffener 108. By including slit openings 135 at the end of stiffener 108, the stiffness of stiffener 108 may be reduced at the end of headband portion 64.

As another illustrative example, as shown in FIG. 11C, stiffener 108 may be cut at the end of headband portion 64, such as with a V-shape or other suitable shape. Region 122 of headband portion 64 may be free from stiffener structures, and additional stiffeners 126 may be formed at the end of headband portion 64. In some embodiments, the stiffness of additional stiffeners 126 may be less than the stiffness of stiffener 108 to reduce the stiffness at the end of headband portion 64. Alternatively or additionally, the presence of region 122 without any stiffening structures may reduce the stiffness at the end of headband portion 64.

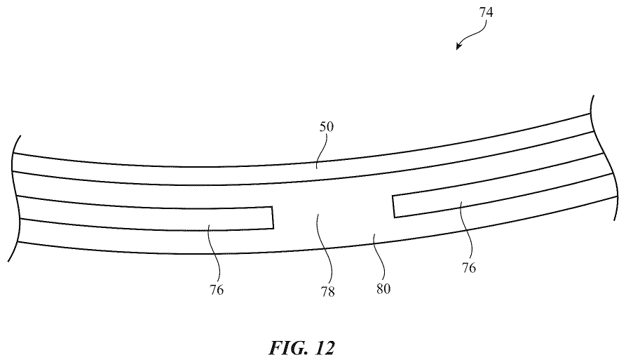

Instead of, or in addition to, including gradually reduced stiffened regions, a headband portion, such as upper headband portion 32 or lower headband portion 34, may include additional structures to help curve the headband portion(s) to fit a user's head. An illustrative example of a headband portion having additional structures is shown in FIG. 12.

As shown in FIG. 12, headband portion 74, which may be upper headband portion 32 or lower headband portion 34, may include fabric 80. Stiffeners 76 may be embedded in fabric 80 (e.g., formed between two outer surfaces and/or layers of fabric 80). Stiffeners 76 may be formed from polymer, such as PET, metal, or other suitable material. For example, stiffeners 76 may be graded stiffeners, such as the graded stiffener of FIGS. 9A and 9B or FIGS. 10A and 10B. Regardless of whether stiffeners 76 have gradually reduced stiffness, stiffeners 76 may be included at the ends of headband portion 74 (e.g., where a post, such as post 24P, is attached to headband portion 74).

Headband portion 74 may include gap 78 between stiffeners 76. In particular, by including gap 78 between stiffeners 76, fabric 80 may conform to the curvature of the user's head, such as at the top or back of the user's head. However, the incorporation of gap 78 is merely illustrative. The entirety of headband portion 74 may include stiffening material, if desired.

Stiffener 50 may be incorporated on at least one edge of headband portion 74. Stiffener 50 may be formed from a cord, such as a braided cord, sheets of fabric, a non-stretch cord, or a flexible strip of polymer (e.g., an elastomer such as thermoplastic polyurethane). Stiffener 50 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffener 50 may significantly less stretchy and soft than the fabric of headband portion 74 and may serve to increase the stiffness and decrease (or eliminate) stretchiness at desired portions along headband portion 74. At the same time, the flexibility of stiffener 50 may allow headband portion 74 to bend around the curvature of a user's head. Stiffener 50 may be inserted into selected portions of headband portion 74 to selectively stiffen headband portion 74 at desired portions along its length, if desired. In this way, stiffener 50 may allow headband portion 74 to conform to the curvature of the user's head, such as at the lower rear portion or the top portion of the head.

Although stiffener 50 is shown on only one edge of headband portion 74, stiffener 50 may be incorporated along one or both edges of headband portion 74. By including stiffener 50 on one or both edges of headband portion 74, headband portion 74 may conform to the curvature a user's head.

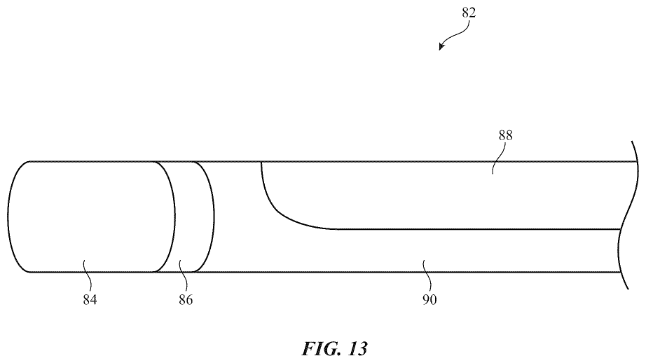

In addition to, or instead of, incorporating stiffener 50 to allow headband portion 74 to conform to a user's head, a headband portion may include polymer or other material that spans a greater width of the headband portion. An illustrative example is shown in FIG. 13.

As shown in FIG. 13, headband portion 82, which may be upper headband portion 32 or lower headband portion 34, may include fabric 90. Stiffener 88 may be embedded in fabric 90 (e.g., formed between two outer surfaces and/or layers of fabric 90). Stiffener 88 may be a polymer, such as PET, thermoplastic polyurethane (TPU), metal, or other material. Stiffener 88 may extend along most of the length of headband portion 82, while extending at least 50% across the width of headband portion 82, as an example. In general, however, stiffener 88 may extend along any suitable length and width of headband portion 82. Stiffener 88 may ensure that headband portion 82 is stiffer on one side (e.g., the top side of FIG. 13), and therefore conform to the curvature of a user's head.

Stiffeners 84 and 86 may form a graded stiffener (as shown in FIGS. 9A and 9B and/or FIGS. 10A and 10B). Regardless of whether stiffeners 84 and 86 have gradually reduced stiffness, however, stiffeners 84 and 86 may be included at the ends of headband portion 82 (e.g., where a post, such as post 24P, is attached to headband portion 82).

Although not shown in FIG. 13, less stiff material, such as polyethylene terephthalate glycol (PETG) or a liquid crystal polymer (LCP), may be incorporated into the region of fabric 90 and surround the region in which stiffener 88 is formed. Therefore, whether fabric 90 alone surrounds stiffener 88, or another material that is less stiff than stiffener 88 is incorporated into headband portion 82, stiffener 88 may provide headband portion 82 with increased stiffness at an edge of the strap portion and allow for the strap portion to conform to the user's head.

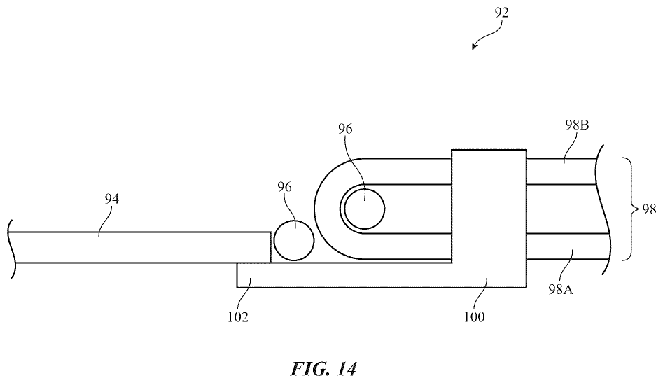

In some embodiments, a keeper loop may be incorporated between portions of a headband to allow for the headband to be adjusted, while maintaining the positions of the portions of the headband relative to one another. An illustrative example of a headband with a keeper loop is shown in FIG. 14.

As shown in FIG. 14, headband 92 (which may correspond with headband 26 of FIG. 2), may have headband portions 94 and 98 (which may correspond with double-backed portion 33 and a double-backed portion of lower headband portion 34 of FIG. 2, or any other suitable portion of headband 26). In some embodiments, headband portion 94 may correspond to an add-on headband that terminates in a connector, such as a connector to attach to post 24P (FIG. 1). In general, however, headband portions 94 and 98 may correspond with any desired portions of a headband.

Adjuster loop 96 (which may correspond with adjustment loop 36 or 38 of FIG. 2, for example) may be coupled to headband portion 94. For example, headband portion 94 may be adhesively coupled to adjuster loop 96, may be tied around adjuster loop 96, may be received within a cavity of adjuster loop 96, or otherwise may be attached to adjuster loop 96.

Headband portion 98 may have first portion 98A and second portion 98B separated by a portion of adjuster loop 96. In other words, second portion 98B may double back on first portion 98A after passing through adjuster loop 96. By adjusting the amount of headband portion 98 that passes through adjuster loop 96, the size of headband 92 may be adjusted.

Keeper loop 100 may be included in headband 92 to maintain the position of headband portions 94, 98A, and 98B. Keeper loop 100 may be formed from reinforced fabric. For example, keeper loop 100 may be reinforced with one or more polyethylene terephthalate (PET) layers or other polymer layers, one or more fiberglass layers, one or more adhesive layers, and/or one or more fabric layers. These layers may then be covered by a fabric, such as a webbing.

Keeper loop 100 may have portion 102 attached to headband portion 94, such as using an adhesive. Alternatively, portion 102 may be woven or otherwise attached to headband portion 94. By attaching portion 102 of keeper loop 100 to headband portion 94, keeper loop 100 may maintain its position relative to headband portion 94, preventing keeper loop 100 from sliding down headband portion 98.

Although FIG. 14 shows keeper loop 100 attached headband portion 94 directly, keeper loop 100 may be attached to (e.g., tucked into an opening of) adjuster loop 96, if desired.

First and second portions 98A and 98B of headband portion 98 may pass through keeper loop 100. Keeper loop 100 may keep headband portion 98 flat and minimize the bend radius between portions 98A and 98B, allowing headband 92 to have a low profile. In particular, the position of keeper loop 100 relative to adjuster loop 96 may minimize this bend radius.

As shown in FIG. 14, adjuster loop 96 may be oriented at an angle relative to the plane of headband portion 94, such as with an angle of at least 20°, at least 30°, or at least 40°, as examples. By orienting adjuster loop 96 in this way, portion 98A of headband portion 98 may be aligned with headband portion 94 (e.g., the plane of portion 98A may be coplanar with the plane of headband portion 94). Aligning portion 98A with headband portion 94 may allow for headband 92 to be more comfortable when worn, allow for easier adjustments of headband 92, and/or prevent adjuster loop 96 from contacting the user's head.

Keeper loop 100 may maintain the curvature of headband 92 when headband 92 is not being worn. In particular, because keeper loop 100 is attached to headband portion 94 and to headband portion 98, the shape of headband 92 may be maintained when it is not on a user's head. Similarly, because keeper loop 100 contacts both sides of the headband, keeper loop 100 may prevent the headband from becoming disconnected if it is not properly fastened.

When headband 92 is worn, keeper loop 100 may separate adjuster loop 96 from the user's head. Additionally or alternatively, the friction between keeper loop 100 and headband portion 98 may prevent headband portion 98 from moving relative to adjuster loop 96.

Although FIG. 14 shows portions 98A and 98B passing through a common opening of keeper loop 100, this is merely illustrative. Keeper loop 100 may have two openings, with portions 98A and 98B each passing through one of the openings, if desired. For example, fabric, which may be reinforced with PET, fiberglass, and/or other material, may separate the two openings.

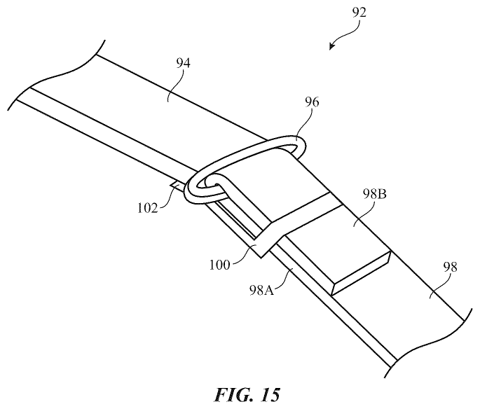

An illustrative perspective view of headband 92 with keeper loop 100 is shown in FIG. 15. As shown in FIG. 15, the use of keeper loop 100 may maintain a small bend radius between portions 98A and 98B of headband portion 98 as it passes through adjuster loop 96.

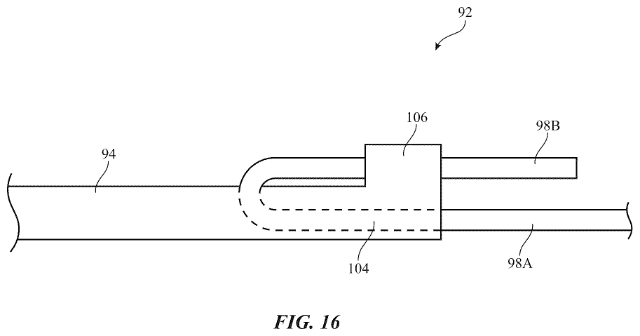

In some embodiments, adjuster loop 96 may be omitted. An illustrative example of a headband without an adjuster loop is shown in FIG. 16.

As shown in FIG. 16, headband portion 94 of headband 92 may include cavity 104 and integral keeper loop 106. Keeper loop 106 may be formed from the same materials as keeper loop 100 (FIG. 14). For example, the fabric layer(s) of keeper loop 106 may be woven or otherwise attached to the fabric of headband portion 94.

Portion 98A of headband portion 98 may pass through cavity 104 before doubling back as headband portion 98B through keeper loop 106. In this way, an adjuster loop may be omitted from headband 92, and headband portion 98 may still have a low profile due to keeper loop 106.

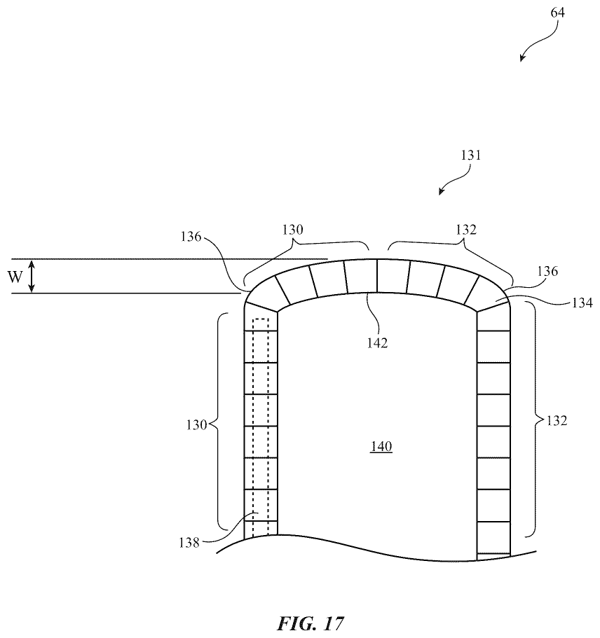

In some embodiments, it may be desirable to create a curved edge that appears seamless at the end of a headband, such as at the end of headband portion 64. An illustrative headband portion with a curved edge with a seam that is invisible to the naked eye is shown in FIG. 17.

As shown in FIG. 17, strap 131 may be formed from inner woven portion 140 and webbing 134. In particular, webbing 134 may be sewn, woven, or otherwise coupled to woven portion 140. Webbing 134 may have a width W from edge 142 of woven portion 140 of at least 2 mm, of 2.65 mm, of 5 mm, of between 2.5 mm and 5 mm, or of less than 7 mm, as examples. Woven portion 140 may have a solid loop weave or a ribbed loop weave, as examples.

Although portion 140 has been described as being woven, this is merely illustrative. In general, portion 140 may be knitted, woven, braided, and/or formed using other strand intertwining techniques.

Webbing 134 may have portion 130 that wraps from one side of inner woven portion 140 (e.g., the left side of inner woven portion 140 in FIG. 17), across part of edge 142. Additionally, webbing 134 may have portion 132 that wraps from an opposing side of inner woven portion 140 (e.g., the right side of inner woven portion 140 in FIG. 17) across part of edge 142. Portions 130 and 132 may meet along edge 142, such as in the center of edge 142.

A stiffener may be inserted into webbing 134, if desired. In the illustrative example of FIG. 17, stiffener 138 may be inserted into webbing 134, such as one side of webbing 134. In particular, webbing 134 may have multiple layers, and stiffener 138 may be inserted between the multiple layers. Alternatively, webbing 134 may be formed as a single piece using a flat knitting technique and includes a built-in channel (sometimes referred to as a pocket or cavity), and stiffener 138 may be inserted into the built-in channel. In general, however, stiffener 138 may be inserted into webbing 134 in any desired manner.

Stiffener 138 may be formed from a cord, such as a braided cord, or a flexible strip of polymer (e.g., an elastomer such as thermoplastic polyurethane). Stiffener 138 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffener 138 may be significantly less stretchy and soft than the fabric of strap 131 and may serve to increase the stiffness and decrease (or eliminate) stretchiness at desired portions along strap 131. At the same time, the flexibility of stiffener 138 may allow strap 131 to bend around the curvature of a user's head. Stiffener 138 may be inserted into selected portions of strap 131 to selectively stiffen strap 131 at desired portions along its length, if desired. For example, stiffener 138 may be inserted into one or both sides of strap 131 and/or an edge of strap 131.

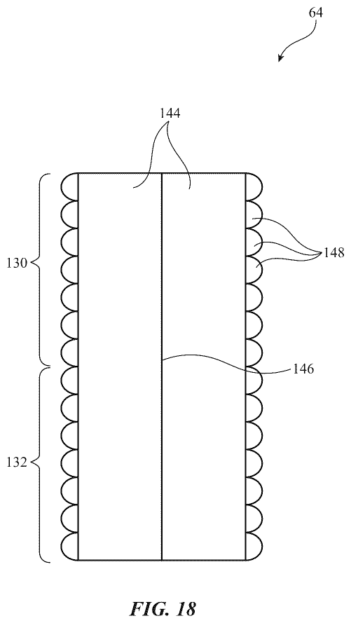

Headband portion 64 may have rounded corners 136 of webbing 134 and may not have visible seams (e.g., where portions 130 and 132 meet). An illustrative side view of headband portion 64 is shown in FIG. 18.

As shown in FIG. 18, headband portion 64 may include layers 144 and loops 148 (e.g., in webbing 134 of FIG. 17). Webbing from one side of headband portion 64 (e.g., portion 130) may be bonded to the webbing from the other side of headband portion 64 (e.g., portion 132) at point 146 (e.g., headband portion 64 may have single seam at point 146, such as along edge 142 of FIG. 17). As shown in FIG. 18, there may be no visible seam at point 146. In this way, a seam that is not visible to the naked eye may be formed in headband portion 64.

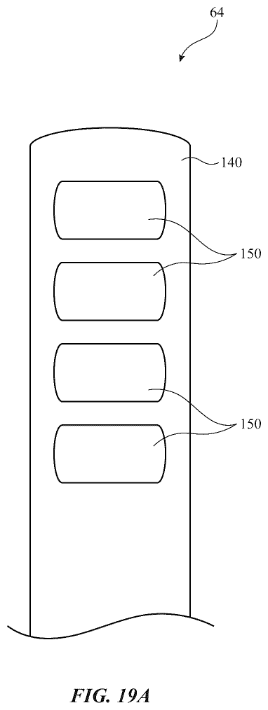

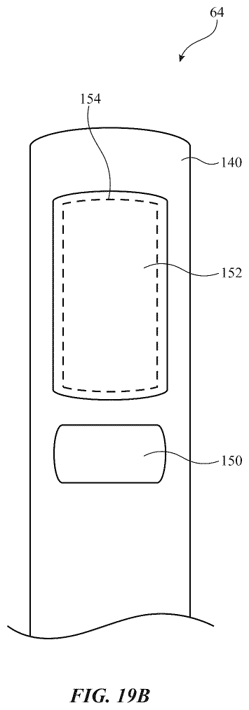

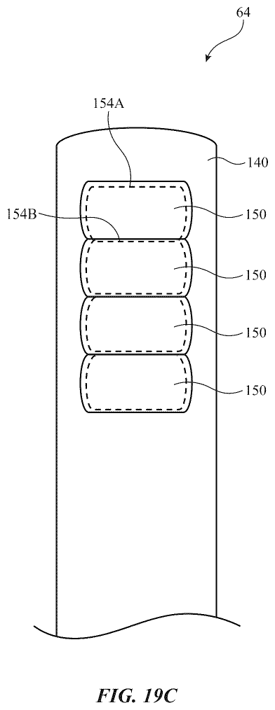

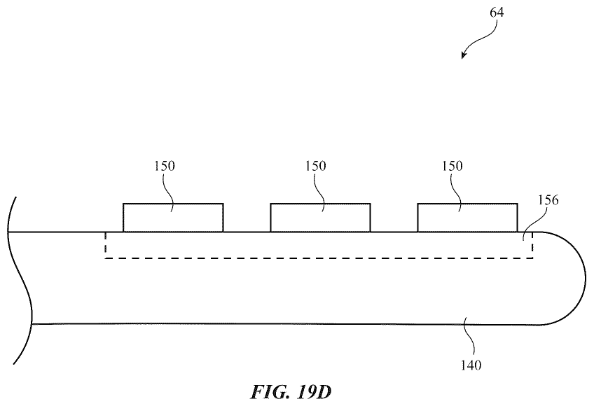

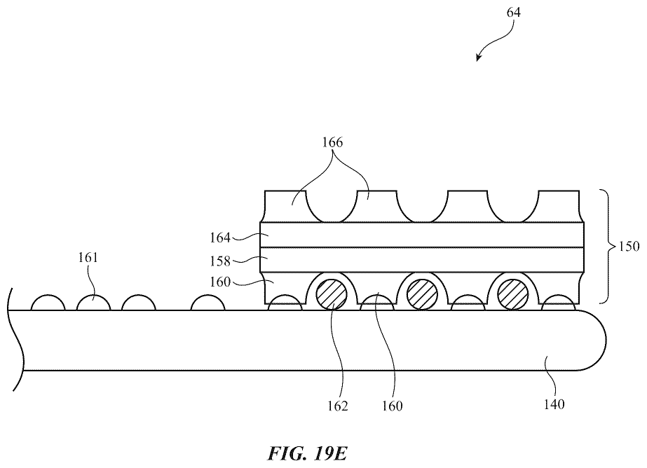

In some embodiments, hook and loop fasteners (or other suitable fasteners) may be incorporated into a headband to allow the headband to be adjusted and to maintain the position of the headband once it is adjusted. The hook and loop fasteners may be coupled to the headband using adhesive, sewing the fasteners to the headband, and/or partially embedding the fasteners within the headband. Illustrative examples are shown in FIGS. 19A-19E.

As shown in FIG. 19A, hook and loop fasteners 150 may be coupled to portion 140 of headband portion 64. For example, hook and loop fasteners may be adhesively attached to headband portion 64.

Alternatively, as shown in the illustrative example of FIG. 6B, a single, large hook and loop fastener 152 may replace one or more of hook and loop fasteners 150. Hook and loop fastener 152 may be stitched to, knitted to, adhesively attached to, and/or otherwise attached to headband portion 64. As indicated by stitch line 154, for example, hook and loop fastener 152 may be stitched to headband portion 64.

As another example, multiple hook and loop fasteners 150 may be used and may have adjoining edges. As shown in the illustrative example of FIG. 19C, hook and loop fasteners 150 may abut one another. As indicated by stitch line 154A, each individual hook and loop fastener 150 may be stitched to headband portion 64. At the adjoining edges of adjacent hook and loop fasteners 150, shared stitch line 154B may be used to fasten the adjacent hook and loop fasteners 150 together and to headband portion 64. However, the use of fastening hook and loop fasteners 150 to headband portion 64 by stitching is merely illustrative. In general, hook and loop fasteners 150 may be coupled to headband portion 64 in any suitable manner, such as by knitting, adhering, and/or otherwise attaching hook and loop fasteners 150 to headband portion 64.

In some embodiments, hook and loop fasteners 150 may be formed on a substrate that is at least partially embedded within a headband. As shown in the illustrative example of FIG. 19D, hook and loop fasteners 150 may be formed on substrate 156. Substrate 156 may be embedded within headband portion 64, such as within woven portion 140. For example, headband portion 64 may have two fabric layers that face outwardly, and substrate 156 may be formed between the two fabric layers. In addition to embedding substrate 156 in headband portion 64, substrate 156 may be stitched to, adhered to, or otherwise attached to headband portion 64. In this way, hook and loop fasteners 150 may be further attached to headband portion 64.

As another example, double-sided hook and loop fasteners may be attached to a headband. In the illustrative example of FIG. 19E, hook and loop fastener 150 may include lower fasteners 160 formed on carrier 158 and upper fasteners 166 formed on carrier 164. Carriers 158 and 164 may be coupled to one another, such as with an adhesive. Lower fasteners 160 may be coupled to loops 161 on a surface of headband portion 64 (e.g., a portion of woven portion 140). Lower fasteners 160 may also optionally be attached to headband portion 64 using adhesive 162, if desired. Upper fasteners 166 may be used to couple headband portion 64 to another headband portion or to itself (e.g., if headband portion 64 doubles back on itself) to maintain the position of headband portion 64 after it is adjusted.

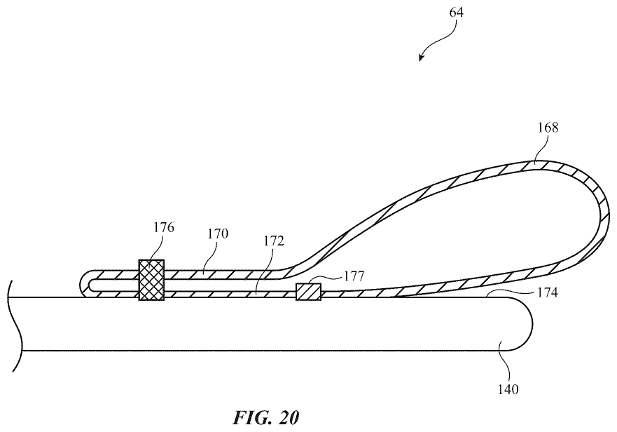

Regardless of the fasteners used to maintain the position of a headband, such as headband portion 64, it may be desirable to incorporate one or more pull tabs to adjust the headband portion. An illustrative example is shown in FIG. 20.

As shown in FIG. 20, pull tab 168 may be incorporated in headband portion 64, such as at the end of headband portion 64. In some embodiments, pull tab 168 may be formed on an opposite surface of headband portion 64 from hook and loop fasteners 150 (FIG. 19).

Pull tab 168 may have lower portion 172 in contact with upper surface 174 of headband portion 64. In particular, stitch 176 may be used to attach pull tab 168 to headband portion 64. Stitch 176 may extend through upper portion 170 and lower portion 172 of pull tab 168 and may attach pull tab 168 to headband portion 64. Lower portion 172 may be further attached to headband portion 64 using stitch 177. In this way, pull tab 168 may form a loop that is attached to one surface of headband portion 64 and that may be pulled by a user to release headband portion 64 (e.g., to adjust the fit of headband portion 64).

Although stitches 176 and 177 have been shown and described as stitches, this is merely illustrative. In general, pull tab 168 may be attached to headband portion 64 in any suitable manner, such as with an adhesive, using laser welding, or another suitable attachment.

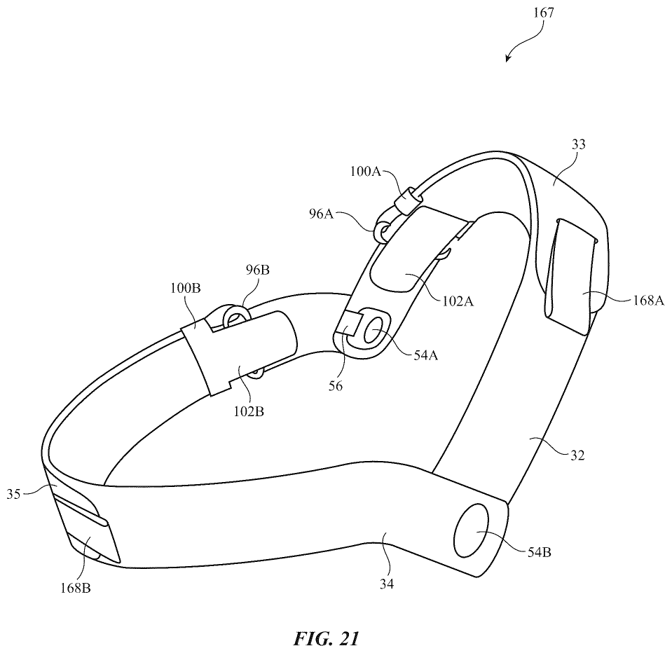

An illustrative example of a headband system that includes adjuster loops, keeper loops, and pull tabs is shown in FIG. 21.

As shown in FIG. 21, headband system 167 may include upper headband 32 and lower headband 34. Upper headband 32 may be coupled to lower headband 34, such as by stitching, knitting, laser welding, adhesive, and/or any other suitable fastener.

Upper headband 32 may include keeper loop 100A with portion 102A. In particular, upper headband 32 may extend through keeper loop 100A, through keeper loop 96A, and may double back through keeper loop 100A. Double-backed portion 33 of upper headband 32 may have pull tab 168A at the end of doubled-back portion 33. On the opposite surface of double-backed portion 33, one or more hook and loop fasteners (e.g., hook and loop fasteners 150 of FIG. 19) may be attached to secure double-backed portion 33 in place after it is adjusted.

Similarly, lower headband 34 may include keeper loop 100B with portion 102B. In particular, lower headband 34 may extend through keeper loop 100B, through keeper loop 96B, and may double back through keeper loop 100B. Double-backed portion 35 of lower headband 34 may have pull tab 168B at the end of double-backed portion 35. On the opposite surface of double-backed portion 35, one or more hook and loop fasteners (e.g., hook and loop fasteners 150 of FIG. 19) may be attached to secure double-backed portion 35 in place after it is adjusted.

The arrangement of FIG. 21 is merely illustrative of a headband system that may include adjuster loops, keeper loops, and pull tabs. In general, one or more adjuster loops, keeper loops, and pull tabs may be incorporated into a headband system in any suitable manner.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A headband operable with a head-mounted device having a head-mounted housing member, the headband comprising:
an upper headband portion;
a lower headband portion that extends from the upper headband portion, wherein the upper headband portion and the lower headband portion are configured to be coupled to the head-mounted housing member, the upper headband portion extends from the head-mounted housing member at an angle of at least 80°, and the lower headband portion extends from the head-mounted housing member at an angle of at least 35°; and
stiffeners in the upper and lower headband portions.

2. The headband of claim 1, further comprising:
a temple housing coupled to the upper and lower headband portions, wherein the temple housing comprises an opening that is configured to be coupled to the head-mounted housing member.

3. The headband of claim 2, wherein the temple housing comprises rigid polymer.

4. The headband of claim 3, wherein the upper and lower headband portions comprise a surface, and the temple housing is coupled to the surface.

5. The headband of claim 3, wherein the upper and lower headband portions comprise fabric, and the temple housing is embedded in the fabric.

6. The headband of claim 2, wherein the temple housing extends into the upper and lower headband portions.

7. The headband of claim 2, wherein the temple housing is interposed between the upper and lower headband portions, and the temple housing has first and second edges that are respectively coupled to the upper and lower headband portions.

8. The headband of claim 1, wherein the upper headband portion is offset from the head-mounted housing member by at least 10 mm, and the lower headband portion is offset from the head-mounted housing member by at least 15 mm.

9. The headband of claim 1, wherein the upper headband portion is offset from the head-mounted housing member by 0 mm, and the lower headband portion is offset from the head-mounted housing member by between 18 mm and 35 mm.

10. The headband of claim 1, further comprising:
first and second adjustment loops, wherein the upper and lower headband portions comprise double-backed portions that respectively pass through the first and second adjustment loops.

11. The headband of claim 10, further comprising:
first and second soft keeper loops, wherein the double-backed portions of the upper and lower headband portions are respectively configured to pass through the first and second soft keeper loops.

12. The headband of claim 11, further comprising:
first and second pull tabs respectively coupled to single surfaces of the double-backed portions of the upper and lower headband portions; and
hook and loop fasteners coupled to opposing surfaces of the double-backed portions.

13. The headband of claim 12, wherein the upper and lower headband portions comprise fabric, the hook and loop fasteners are formed on substrates, and the substrates are embedded within the fabric.

14. The headband of claim 1, wherein the stiffeners comprise stiffeners in the upper headband portion with gradually reduced stiffness between a first stiffened region and a second stiffened region.

15. The headband of claim 14, wherein the first stiffened region comprises an opening that is configured to be coupled to the head-mounted housing member.

16. The headband of claim 15, wherein the stiffeners further comprise a braided cord that extends along an edge of the lower headband portion.

17. A head-mounted device headband operable with a head-mounted device housing, comprising:
a first end configured to couple to a first side of the head-mounted device housing;
a second end configured to couple to an opposing second side of the head-mounted device housing;
an upper headband portion that extends between the first end and the second end, wherein the upper headband portion comprises a first region with a first stiffness, a second region with a second stiffness that is less than the first stiffness, and a graded stiffness between the first region and the second region; and
a lower headband portion that extends between the first end and the second end, wherein the lower headband portion comprises a stiffener that extends along an edge of the lower headband portion.

18. The head-mounted device headband of claim 17, wherein the upper headband portion is configured to be worn on a top portion of a user's head, and the lower headband portion is configured to be worn on a lower rear portion of the user's head.

19. The head-mounted device headband of claim 18, wherein the upper headband portion and the lower headband portion are attached with an adhesive, the upper headband portion and the lower headband portion comprise an opening configured to attach to the head-mounted device housing, and the first region of the upper headband portion includes the opening.

20. The head-mounted device headband of claim 18, wherein the upper headband portion and the lower headband portion are formed integrally with each other.

21. The head-mounted device headband of claim 18, further comprising:
a temple housing coupled to the upper headband portion and the lower headband portion, wherein the temple housing comprises an opening configured to attach to the head-mounted device housing.

22. A headband configured to couple to a support member of a head-mounted device housing, the headband comprising:
an upper headband portion;
a lower headband portion that extends from the upper headband portion; and
a temple housing coupled to the upper and lower headband portions, wherein the temple housing comprises an opening that is configured to attach to the support member, and the upper headband portion comprises a graded stiffener adjacent to the temple housing.

23. The headband of claim 22, wherein the upper headband portion comprises a first portion, a second portion, and a keeper loop attached to the first portion, and wherein the second portion passes through and doubles back through the keeper loop.

24. The headband of claim 23, wherein the upper headband portion further comprises an adjuster loop, wherein the second portion doubles back around the adjuster loop.

25. The headband of claim 23, wherein the keeper loop is formed integrally with the first portion.

26. The headband of claim 23, wherein the keeper loop comprises fabric reinforced with polymer.

27. The headband of claim 23, wherein the keeper loop is a first keeper loop, and the lower headband portion comprises a second keeper loop.

28. The headband of claim 22, wherein the graded stiffener comprises first and second stiffener layers and a stiffener encapsulation layer that has a thickness that varies gradually along a curved profile.

29. The headband of claim 22, wherein the upper headband portion comprises a strap that includes woven fabric portion surrounded by a webbing, the webbing has rounded corners at an edge of the woven fabric portion, the webbing has a first portion and a second portion, and the first and second portions of the webbing meet at a seam that is invisible to a naked eye.
